(19) United States
(12) Patent Application Publication
(10) Pub. No.: US 2015/0188348 A1
(43) Pub. Date: Jul. 2, 2015

(54) POWER SUPPLY CIRCUIT AND ELECTRONIC DEVICE

(71) Applicant: Kabushiki Kaisha Toshiba, Tokyo (JP)

(72) Inventor: Ryuhei YOKOTA, Tachikawa Tokyo (JP)

(21) Appl. No.: 14/558,540

(22) Filed: Dec. 2, 2014

(30) Foreign Application Priority Data
Dec. 27, 2013 (JP) 2013-272578

(51) Int. Cl. H02J 7/00

(52) U.S. Cl. CPC H02J 7/0068; H02J 7/0072

(57) ABSTRACT

According to one embodiment, a power supply circuit includes a battery, a first manually-operated switch, a second switch, and a maintaining circuit. The first manually-operated switch includes a normally open contact point. The second switch has a closed state and an open state. When in the closed-state, the second switch is configured to supply electric power of the battery to a target circuit. When in the open state, the second switch is configured to shut off the electric power of the battery to the target circuit. The maintaining circuit is configured to maintain the second switch in the closed state when the first switch is continuously closed for greater than or equal to a first time.

### CROSS-REFERENCE TO RELATED APPLICATIONS

This application is based upon and claims the benefit of priority from Japanese Patent Application No. 2013-272578, filed Dec. 27, 2013, the entire contents of which are incorporated herein by reference.

### FIELD

Embodiments described herein relate generally to a power supply circuit and an electronic device.

### BACKGROUND

Conventionally, an electronic device comprising a built-in battery circuit cannot be packed and shipped while a battery being removed.

When such an electronic device is sold to a customer at stores, the electronic device that is to be actually purchased by the customer is usually used to explain how to operate the electronic device.

Therefore, it is necessary for the built-in battery of the conventional electronic device to have sufficient residual capacity for initial operation. For this purpose, dark current in the system is reduced to prolong a battery residual capacity maintainable period.

However, in the conventional device, it has been difficult to maintain the battery residual capacity for a long period of time due to leakage current in devices mounted to the system.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram of a schematic configuration of an electronic device according to an embodiment;

FIG. 2 is an exemplary diagram of a schematic configuration of a charge and discharge control unit according to a first embodiment;

FIG. 3 is an exemplary diagram for explaining a schematic configuration of an electronic device according to a second embodiment;

FIG. 4 is an exemplary diagram for explaining a schematic configuration of an electronic device according to a third embodiment; and

FIG. 5 is an exemplary diagram for explaining a schematic configuration of an electronic device according to a fourth embodiment.

### DETAILED DESCRIPTION

In general, according to one embodiment, a power supply circuit comprises a battery, a first manually-operated switch, a second switch, and a maintaining circuit. The first manually-operated switch comprises a normally open contact point. The second switch has a closed state and an open state. When in the closed-state, the second switch is configured to supply electric power of the battery to a target circuit. When in the open state, the second switch is configured to shut off the electric power of the battery to the target circuit. The maintaining circuit is configured to maintain the second switch in the closed state when the first switch is continuously closed for greater than or equal to a first time.

The following describes preferred embodiments with reference to the accompanying drawings.

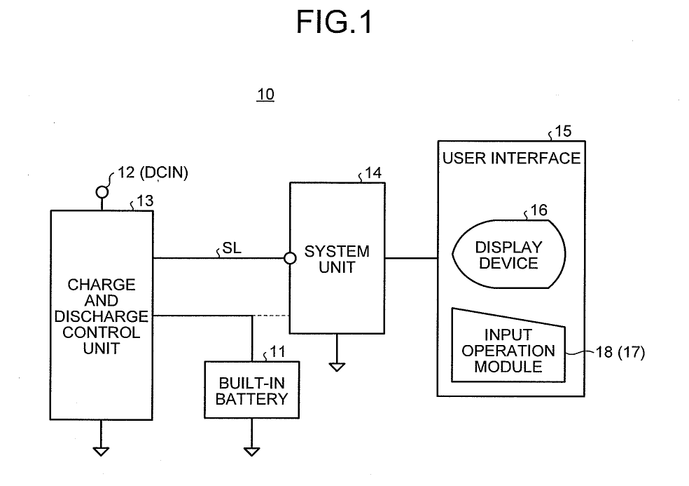

FIG. 1 is a block diagram of a schematic configuration of an electronic device according to an embodiment.

An electronic device 10 comprises: a built-in battery 11; a charge and discharge control unit 13; a system unit 14; and a user interface 15. The charge and discharge control unit 13 comprises a direct current power supply terminal 12 to which an external direct current power supply is connected, and performs charge and discharge control of the built-in battery 11. The system unit 14 controls the entire electronic device 10 with electric power stored in the built-in battery 11 or supplied from the external direct current power supply via the direct current power supply terminal 12. The user interface 15 comprises a touch panel display.

The user interface 15 comprises a display 16 and an input operation module 18. The display 16 displays various pieces of information. The input operation module 18 comprises a touch panel and operation buttons including a power supply button 17.

### First Embodiment

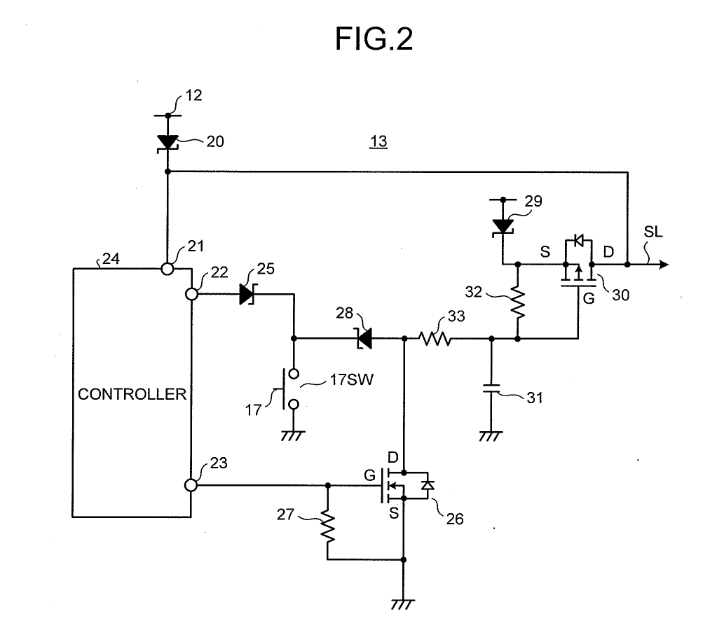

FIG. 2 is a schematic diagram of a charge and discharge control unit according to a first embodiment.

The charge and discharge control unit 13 comprises a controller 24 and a first reverse blocking diode 25. The controller 24 comprises: a power supply input terminal 21 connected to the direct current power supply terminal 12 via a reverse blocking diode 20; a normally power-ON terminal 22; and a power supply status terminal 23. The controller 24 performs power supply management and charging control of the built-in battery 11. An anode terminal A of the first reverse flow blocking diode 25 is connected to the normally power-ON terminal 22, and a cathode terminal K thereof is connected to a switch 17SW having a normally open contact point linked with the power supply button 17.

The charge and discharge control unit 13 also comprises: an n-type metal-oxide-semiconductor (NMOS) transistor 26; a resistor 27; and a second reverse blocking diode 28. The gate terminal G of the NMOS transistor 26 is connected to the power supply status terminal 23. A source terminal S of the NMOS transistor 26 is grounded. The resistor 27 is connected between the gate terminal G and the source terminal S of the NMOS transistor 26. The cathode terminal K of the second reverse blocking diode 28 is connected to the cathode terminal K of the first reverse blocking diode 25. An anode terminal A of the second reverse blocking diode 28 is connected to a drain terminal D of the NMOS transistor 26.

The charge and discharge control unit 13 also comprises: a third reverse blocking diode 29; a p-type metal-oxide-semiconductor (PMOS) transistor 30; a capacitor 31; a resistor 32; and a current limiting resistor 33. The anode terminal A of the third reverse blocking diode 29 is connected to a high-potential side terminal of the built-in battery 11. The source terminal S of the PMOS transistor 30 is connected to a cathode terminal K of the third reverse blocking diode, and a drain terminal D of the PMOS transistor 30 is connected to a high-potential side power terminal 14P of the system unit 14 and the power supply input terminal 21. The capacitor 31 is for defining long pressing time of the power supply button 17 of which one end is connected to a gate terminal G of the PMOS transistor 30 and the other end thereof is grounded. The resistor 32 is connected between the gate terminal G and the source terminal S of the PMOS transistor 30. The current limiting resistor 33 is connected to the gate terminal G of the PMOS transistor 30 and the anode terminal of the second reverse blocking diode 28.

The following describes an operation according to the first embodiment.

The following describes a case in which an external direct current power supply (for example, an AC/DC adapter) is not connected to the power supply input terminal 21 via the direct current power supply terminal 12.

In an initial state, the power supply status terminal 23 is at an “L” level, so that the gate terminal G of the NMOS transistor 26 is at the “L” level and in an “OFF” state.

The capacitor 31 is at a charged state (at an “H” level), so that the gate terminal G of the PMOS transistor 30 is at the “H” level and in the “OFF” state.

In this state, when a user presses the power supply button 17, the switch 17SW having the normally open contact point linked with the power supply button 17 is caused to be in an “ON” state.

As a result, the capacitor 31 is grounded via the current limiting resistor 33 and the second reverse blocking diode 28, and starts discharging.

When time corresponding to a time constant defined by the capacitor 31 and the current limiting resistor 33 has elapsed, the capacitor 31 is caused to be at a discharged state (at the “L” level).

Accordingly, the gate terminal G of the PMOS transistor 30 is caused to be at the “L” level, and the PMOS transistor 30 is caused to be in the “ON” state.

When the PMOS transistor 30 is in the “ON” state, electric power of the built-in battery 11 is supplied to the power supply input terminal 21 of the controller 24 from the high-potential side terminal of the built-in battery 11 via the third reverse blocking diode 29, the source terminal S of the PMOS transistor 30, and the drain terminal D of the PMOS transistor 30. Accordingly, a predetermined driving voltage is applied to the power supply input terminal 21.

When the predetermined driving voltage is applied to the power supply input terminal 21, the controller 24 starts operation to fix the power supply status terminal 23 at the “H” level.

When the power supply status terminal 23 is at the “H” level, the NMOS transistor 26 is in the “ON” state. Accordingly, even when a user stops pressing the power supply button 17 thereafter, the gate terminal G of the PMOS transistor 30 is maintained at the “L” level and the PMOS transistor 30 is continued to be at the “ON” state.

Accordingly, electric power stored in the built-in battery 11 is supplied to the system unit 14, and the system unit 14 controls the entire electronic device 10.

As described above, according to the first embodiment, the system unit 14 and the controller 24 are shut off from the built-in battery 11 until the user long-presses the power supply button 17. Accordingly, standby current is substantially zero, and it is possible to prolong the battery residual capacity maintainable period of the built-in battery 11.

### Second Embodiment

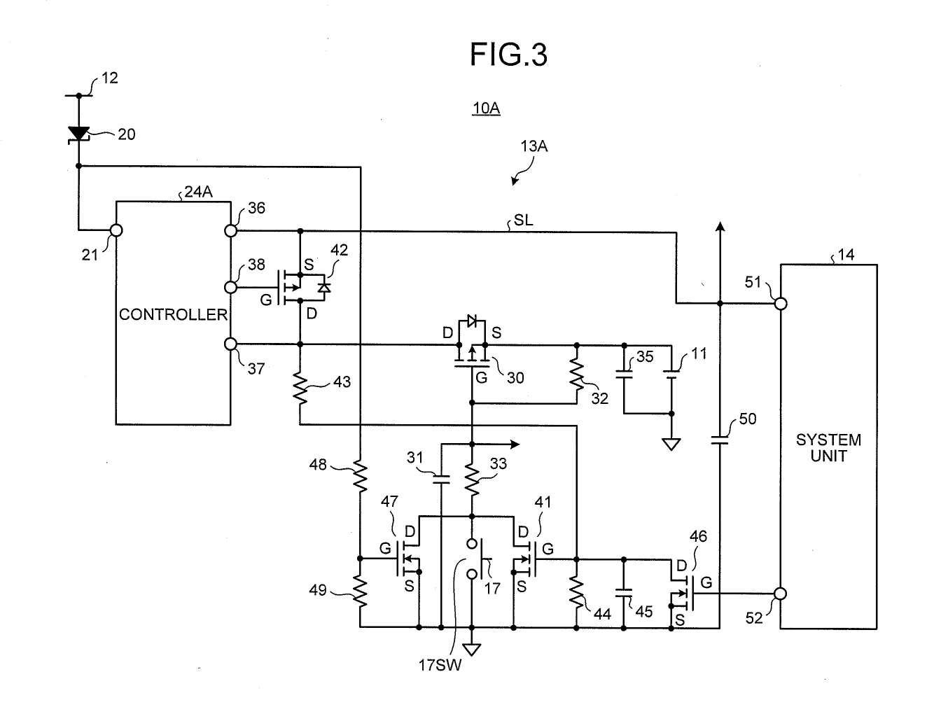

FIG. 3 is a diagram for explaining a schematic configuration of an electronic device according to a second embodiment.

In FIG. 3, the same components as those in FIG. 1 and FIG. 2 are denoted by the same reference numerals.

The second embodiment is different from the first embodiment in that, when the power is once supplied from the power supply, the system unit 14 operates to continue supplying the power.

This electronic device 10A comprises: the built-in battery 11; a capacitor 35; a charge and discharge control unit 13A; the system unit 14; and the user interface 15. The capacitor 35 is connected in parallel with the built-in battery 11 to stabilize an output voltage of the built-in battery 11. The charge and discharge control unit 13A performs charge and discharge control of the built-in battery 11. The system unit 14 controls the entire electronic device 10A with the electric power stored in the built-in battery 11 or supplied from the external direct current power supply via the direct current power supply terminal 12. The user interface 15 comprises the touch panel display.

The user interface 15 comprises the display 16 and the input operation module 18. The display 16 displays various pieces of information. The input operation module 18 comprises the touch panel and the operation buttons including the power supply button 17.

The charge and discharge control unit 13A comprises a controller 24A, the PMOS transistor 30, and the capacitor 31. The controller 24A comprises: the direct current power supply terminal 12; a system power supply terminal 36; a battery terminal 37; and a battery power supply control terminal 38. The external direct current power supply is connected to the direct current power supply terminal 12. The system power supply terminal 36 supplies electric power to the system unit 14 when connected to the external power supply. The battery terminal 37 supplies charging power to the built-in battery 11. The battery power supply control terminal 38 is caused to be at the “H” level when connected to the external direct current power supply. The controller 24A performs power supply management and charge and discharge control of the built-in battery 11. The drain terminal D of the PMOS transistor 30 is connected to the battery terminal 37, and the source terminal S thereof is connected to the high-potential side terminal of the built-in battery 11. An end of the capacitor 31 for defining long pressing time of the power supply button 17 is connected to the gate terminal G of the PMOS transistor 30, and the other end thereof is grounded.

The charge and discharge control unit 13A also comprises: the resistor 32; the current limiting resistor 33; an NMOS transistor 41; and a PMOS transistor 42. The resistor 32 is connected between the gate terminal G and the source terminal S of the PMOS transistor 30. One end of the current limiting resistor 33 is connected to the gate terminal G of the PMOS transistor 30 and the other end thereof is connected to an end of the switch 17SW. The drain terminal D of the NMOS transistor 41 is connected to a connection point between the current limiting resistor 33 and the switch 17SW, and a source terminal S of the NMOS transistor 41 is grounded. The source terminal S of the PMOS transistor 42 is connected to the system power supply terminal 36, a drain terminal D thereof is connected to the battery terminal 37, and agate terminal G thereof is connected to the battery power supply control terminal 38.

The charge and discharge control unit 13A further comprises: a voltage dividing resistor 43; a voltage dividing resistor 44; a capacitor 45; an NMOS transistor 46; and a capacitor 50. One end of the voltage dividing resistor 43 is connected to the drain terminal D of the PMOS transistor 42, and the other end of the voltage dividing resistor 43 is connected to a gate terminal G of the NMOS transistor 41. One end of the voltage dividing resistor 44 is connected to the gate terminal G of the NMOS transistor 41 and the other end of the voltage dividing resistor 44 is grounded. One end of the capacitor 45 is connected to the gate terminal G of the NMOS transistor 41, and the other end of the capacitor 45 is grounded. One end of the NMOS transistor 46 is connected to the gate terminal G of the NMOS transistor 41, and the other end thereof is grounded. The capacitor 50 is for suppressing voltage variation in a system power supply line SL. One end of the capacitor 50 is connected to a source terminal S of the NMOS transistor 46, and the other end of the capacitor 50 is connected to a system power supply terminal 51 of the system unit 14.

The charge and discharge control unit 13A further comprises: an NMOS transistor 47; a voltage dividing resistor 48; and a voltage dividing resistor 49. The drain terminal D of the NMOS transistor 47 is connected to the connection point between the current limiting resistor 33 and the switch 17SW, and a source terminal S of the NMOS transistor 47 is grounded. One end of the voltage dividing resistor 48 is connected to a cathode terminal K of the reverse blocking diode 20, and the other end of the voltage dividing resistor 48 is connected to a gate terminal G of the NMOS transistor 47. One end of the voltage dividing resistor 49 is connected to the gate terminal G of the NMOS transistor 47, and the other end of the voltage dividing resistor 49 is grounded.

In the above configuration, the system unit 14 comprises the system power supply terminal 51 that is connected to the system power supply terminal 36 and receives electric power supply, and an input and output terminal 52 connected to a gate terminal G of the NMOS transistor 46.

The following describes an operation according to the second embodiment.

The following describes a case in which the external direct current power supply is not connected to the power supply input terminal 21 via the direct current power supply terminal 12.

In the initial state, the capacitor 31 is at the charged state (at the “H” level) , so that the gate terminal G of the PMOS transistor 30 is at the “H” level and in the “OFF” state.

The gate terminals G of the NMOS transistor 41 and the NMOS transistor 47 are grounded and at the “L” level, so that they are in the “OFF” state.

The input and output terminal 52 of the system unit 14 is at the “L” level, so that the gate terminal G of the NMOS transistor 46 is also at the “L” level and in the “OFF” state.

The following describes an operation to drive the electronic device 10A with the built-in battery 11.

In the initial state, when the user presses the power supply button 17, the switch 17SW having the normally open contact point linked with the power supply button 17 is caused to be in the “ON” state.

As a result, the capacitor 31 is discharged via the current limiting resistor 33. When the voltage of the capacitor 31 reaches the voltage corresponding to the “L” level, the gate terminal G of the PMOS transistor 30 is caused to be at the “L” level and the PMOS transistor 30 is caused to be in the “ON” state.

Accordingly, the electric power of the built-in battery 11 is supplied to the voltage dividing resistor 43 and the voltage dividing resistor 44, a divided voltage (=“H” level) between the voltage dividing resistor 43 and the voltage dividing resistor 44 causes the gate terminal G of the NMOS transistor 41 to be at the “H” level, and the NMOS transistor 41 is caused to be in the “ON” state.

In this case, the external direct current power supply is not connected to the direct current power supply terminal 12, so that the battery power supply control terminal 38 is at the “L” level. Accordingly, the PMOS transistor 42 is in the “ON” state, and the electric power stored in the built-in battery 11 is supplied to the system power supply terminal 51 of the system unit 14 via the PMOS transistor 30, the PMOS transistor 42, and the system power supply line SL.

Even when the user stops pressing the power supply button 17 after the NMOS transistor 41 becomes the “ON” state, the gate terminal G of the PMOS transistor 30 is kept at the “L” level and the PMOS transistor 30 is continued to be at the “ON” state.

Accordingly, the electric power stored in the built-in battery 11 is continued to be supplied to the system power supply terminal 51 of the system unit 14 via the PMOS transistor 42 and the system power supply line SL, and the system unit 14 can operate with the built-in battery 11 to control the entire electronic device 10A.

The following describes an operation to stop the drive of the electronic device 10A by the built-in battery 11 and cause it to be in a factory-configured state.

In this case, a system unit 14A causes the input and output terminal 52 of the system unit 14 to be at the “H” level by performing screen setting or a special operation at an operation input module.

Accordingly, the gate terminal G of the NMOS transistor 41 is grounded to be at the “L” level, so that the NMOS transistor 41 is caused to be in the “OFF” state.

As a result, the gate terminal G of the PMOS transistor 30 is caused to be at the power supply voltage of the built-in battery 11, that is, at the “H” level to be at the “OFF” state.

Accordingly, the electronic device 10A is reset to the factory-configured state.

The following describes an operation to drive the electronic device 10A by connecting the external power supply thereto.

In the initial state, when the external direct current power supply is connected to the direct current power supply terminal 12, the electric power from the external direct current power supply is supplied to the system power supply terminal 51 of the system unit 14 via the reverse blocking diode 20, the power supply input terminal 21, and the system power supply terminal 36.

In parallel with supply of the electric power from the external direct current power supply via the system power supply terminal 36, the voltage of the supplied electric power is divided via the voltage dividing resistor 48 and the voltage dividing resistor 49, and the gate terminal G of the NMOS transistor 47 is caused to be at the “H” level.

Accordingly, the NMOS transistor 47 is caused to be at the “ON” state, and the gate terminal G of the PMOS transistor 30 is grounded via the current limiting resistor 33 to be at the “L” level.

The PMOS transistor 30 of which the gate terminal G is at the “L” level is caused to be at the “ON” state, that is, a state in which the electric power can be supplied thereto from the external direct current power supply via the battery terminal 37, and also the built-in battery 11 can be charged under control of the charge and discharge control unit 13A according to the state of the built-in battery 11.

Accordingly, the electric power is continuously supplied from the external direct current power supply to the system unit 14, and the system unit 14 controls the entire electronic device 10 to operate with the electric power from the external direct current power supply.

The electric power from the external direct current power supply is also supplied to the built-in battery 11 to charge it as necessary under the control of the charge and discharge control unit 13A.

As described above, according to the second embodiment, when the external direct current power supply is not connected, the system unit 14 and the controller 24 are shut off from the built-in battery 11 until the user long-presses the power supply button 17. Accordingly, standby current is substantially zero, and it is possible to prolong the battery residual capacity maintainable period of the built-in battery 11.

When the external direct current power supply is connected, the system unit 14 and the controller 24 operate with the electric power from the direct current power supply and the built-in battery 11 can be charged as necessary.

### Third Embodiment

In the first embodiment and the second embodiment, the dark current is reduced in the charge and discharge control unit and the system unit comprised in the electronic device. A purpose of a third embodiment is to prolong the battery residual capacity maintainable period by reducing the dark current in the system unit comprised in the electronic device.

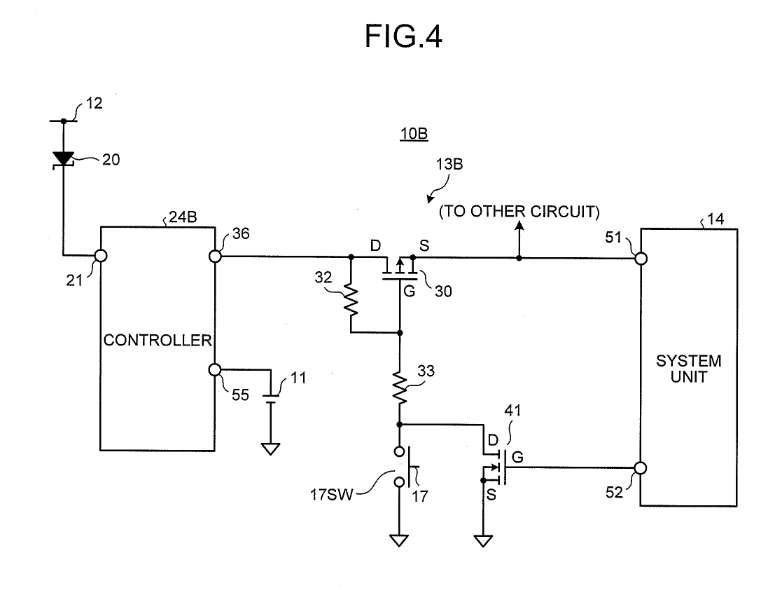

FIG. 4 is a schematic explanatory diagram of the electronic device according to the third embodiment.

In FIG. 4, the same components as those in FIG. 3 are denoted by the same reference numerals.

An electronic device 10B comprises: the built-in battery 11; a charge and discharge control unit 13B; the system unit 14; and the user interface 15. The charge and discharge control unit 13B performs charge and discharge control of the built-in battery 11. The system unit 14 controls the entire electronic device 10B with the electric power stored in the built-in battery 11 or supplied from the external direct current power supply via the direct current power supply terminal 12. The user interface 15 comprises the touch panel display.

The charge and discharge control unit 13B comprises a controller 24B. The controller 24B comprises: the direct current power supply terminal 12 to which the external direct current power supply is connected; the system power supply terminal 36 that supplies the electric power to the system unit 14 when connected to the external power supply; and a battery terminal 55 that supplies charging power to the built-in battery 11 and receives the electric power stored in the built-in battery 11. The controller 24B performs power supply management and charge and discharge control of the built-in battery 11.

The charge and discharge control unit 13B also comprises: the PMOS transistor 30 of which the drain terminal D is connected to the system power supply terminal 36 and the source terminal S thereof is connected to the system power supply terminal 51 of the system unit 14; the resistor 32 connected between the gate terminal G and the drain terminal D of the PMOS transistor 30; the current limiting resistor 33 of which one end is connected to the gate terminal G of the PMOS transistor 30 and the other end thereof is connected to an end of the switch 17SW; and an NMOS transistor 41 of which the drain terminal D is connected to the connection point between the current limiting resistor 33 and the switch 17SW, the source terminal S thereof is grounded, and the gate terminal G thereof is connected to the input and output terminal 52 of the system unit 14.

The following describes an operation according to the third embodiment.

First, the following describes an operation in a case in which the external direct current power supply is not connected to the power supply input terminal 21 via the direct current power supply terminal 12.

In the initial state, the PMOS transistor 30 is assumed to be at the “OFF” state.

The input and output terminal 52 of the system unit 14 is at the “L” level, so that the gate terminal G of the NMOS transistor 56 is also at the “L” level and in the “OFF” state.

When the user presses the power supply button 17, the switch 17SW having the normally open contact point linked with the power supply button 17 is caused to be at the “ON” state.

As a result, the gate terminal G of the PMOS transistor 30 is caused to be at the “L” level and the PMOS transistor 30 is caused to be at the “ON” state.

Accordingly, the charge and discharge control unit 13B supplies the electric power of the built-in battery 11 to the system power supply terminal 51 of the system unit 14 via the system power supply terminal 36 and the PMOS transistor 30.

Accordingly, the system unit 14 causes the input and output terminal 52 to be at the “H” level.

The gate terminal G of the NMOS transistor 41 is thus caused to be at the “H” level and the NMOS transistor 41 is caused to be at the “ON” state.

Even when the user stops pressing the power supply button 17 after the NMOS transistor 41 becomes the “ON” state, the gate terminal G of the PMOS transistor 30 is kept at the “L” level and the PMOS transistor 30 is continued to be at the “ON” state.

Accordingly, the electric power stored in the built-in battery 11 is continued to be supplied to the system unit 14, and the system unit 14 controls the entire electronic device 10B and can operate with the built-in battery.

The following describes an operation to drive the electronic device 10B by connecting the external power supply.

In the initial state, the electric power from the external direct current power supply is ready to be supplied to the system power supply terminal 51 of the system unit 14 via the system power supply terminal 36.

In this state, when the user presses the power supply button 17, the switch 17SW having the normally open contact point linked with the power supply button 17 is caused to be at the “ON” state.

As a result, the gate terminal G of the PMOS transistor 30 is caused to be at the “L” level and the PMOS transistor 30 is caused to be at the “ON” state.

Accordingly, the charge and discharge control unit 13B supplies the electric power of the built-in battery 11 to the system power supply terminal 51 of the system unit 14 via the system power supply terminal 36 and the PMOS transistor 30.

Accordingly, the system unit 14 causes the input and output terminal 52 to be at the “H” level.

The gate terminal G of the NMOS transistor 41 is thus caused to be at the “H” level and the NMOS transistor 41 is caused to be at the “ON” state.

Even when the user stops pressing the power supply button 17 after the NMOS transistor 56 becomes the “ON” state, the gate terminal G of the PMOS transistor 30 is maintained at the “L” level and the PMOS transistor 30 is maintained at the “ON” state.

Accordingly, the electric power stored in the built-in battery 11 is continued to be supplied to the system unit 14, and the system unit 14 controls the entire electronic device 10B and can operate with the electric power from the external direct current power supply.

Thus, according to the third embodiment, a power supply path to the system unit 14 is completely shut off until the power supply button 17 is pressed, so that it is possible to suppress power consumption in the built-in battery 11 due to the dark current flowing in the system unit 14 and to prolong the battery residual capacity maintainable period of the built-in battery 11.

### Fourth Embodiment

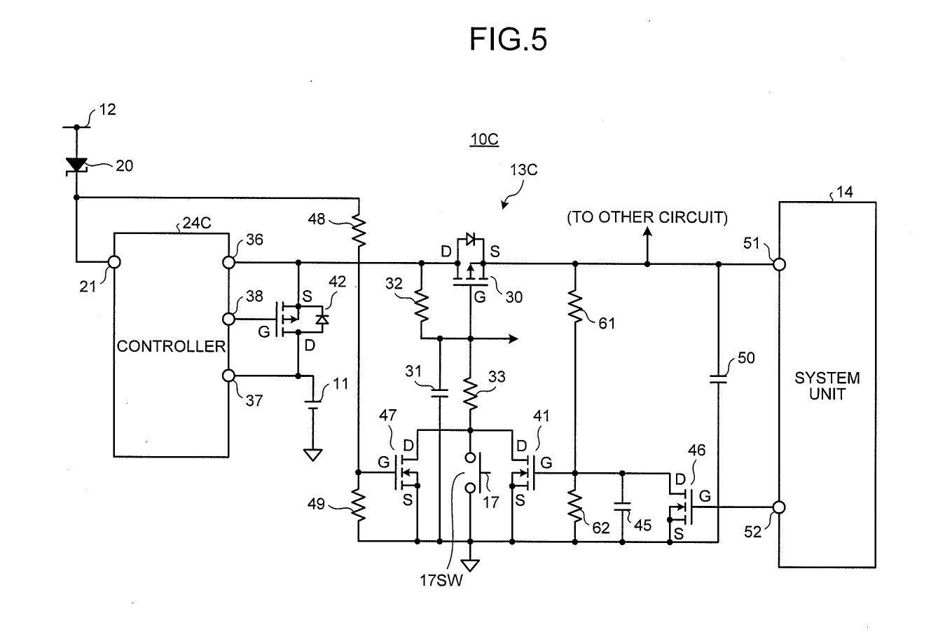

FIG. 5 is a schematic explanatory diagram of the electronic device according to a fourth embodiment.

In FIG. 5, the same components as those in FIG. 3 are denoted by the same reference numerals.

The fourth embodiment is different from the second embodiment in that a purpose thereof is to prolong the residual capacity maintainable period of the built-in battery by reducing the dark current in the system unit comprised in the electronic device, as in the third embodiment.

An electronic device 10C comprises: the built-in battery 11; a charge and discharge control unit 13C that performs charge and discharge control of the built-in battery 11; the system unit 14 that controls the entire electronic device 10C with the electric power stored in the built-in battery 11 or supplied from the external direct current power supply via the direct current power supply terminal 12; and the user interface 15 comprising the touch panel display.

The charge and discharge control unit 13C comprises a controller 24C and the PMOS transistor 30. The controller 24C comprises: the direct current power supply terminal 21 to which the external direct current power supply is connected; the system power supply terminal 36 that supplies the electric power to the system unit 14 when connected to the external power supply; the battery terminal 37 that supplies charging power to the built-in battery 11; and the battery power supply control terminal 38 that is caused to be at the “H” level when connected to the external direct current power supply. The controller 24C performs power supply management and charge and discharge control of the built-in battery 11. The drain terminal D of the PMOS transistor 30 is connected to the system power supply terminal 36, and the source terminal S thereof is connected to the system power supply terminal 51 of the system unit 14.

The charge and discharge control unit 13C comprises: the resistor 32 connected between the gate terminal G and the drain terminal D of the PMOS transistor 30; the current limiting resistor 33 of which one end is connected to the gate terminal G of the PMOS transistor 30 and the other end thereof is connected to an end of the switch 17SW; the NMOS transistor 41 of which the drain terminal D is connected to the connection point between the current limiting resistor 33 and the switch 17SW, and the source terminal S thereof is grounded; and a voltage dividing resistor 61 of which one end is connected to the source terminal S of the PMOS transistor 30 and the other end thereof is connected to the gate terminal G of the NMOS transistor 41.

The charge and discharge control unit 13C further comprises: a voltage dividing resistor 62 of which one end is connected to the gate terminal G of the NMOS transistor 41 and the other end thereof is grounded; the capacitor 45 of which one end is connected to the gate terminal G of the NMOS transistor 41 and the other end thereof is grounded; the NMOS transistor 46 of which one end is connected to the gate terminal G of the NMOS transistor 41 and the other end thereof is grounded, and the capacitor 50 for suppressing voltage variation in the system power supply line SL. One end of the capacitor 50 is connected to the source terminal S of the NMOS transistor 46, and the other end of the capacitor 50 is connected to the system power supply terminal 51 of the system unit 14.

The charge and discharge control unit 13C further comprises: the NMOS transistor 47 of which the drain terminal D is connected to the connection point between the current limiting resistor 33 and the switch 17SW and the source terminal S thereof is grounded; the voltage dividing resistor 48 of which one end is connected to the cathode terminal K of the reverse blocking diode 20 and the other end thereof is connected to the gate terminal G of the NMOS transistor 47; and the voltage dividing resistor 49 of which one end is connected to the gate terminal G of the NMOS transistor 47 and the other end thereof is grounded.

In the above configuration, the system unit 14 comprises: the system power supply terminal 51 that is connected to the system power supply terminal 36 and receives electric power supply; and the input and output terminal 52 connected to the gate terminal G of the NMOS transistor 46.

The following describes an operation according to the fourth embodiment.

The following describes a case in which the external direct current power supply is not connected to the power supply input terminal 21 via the direct current power supply terminal 12.

In the initial state, the capacitor 31 is at the charged state (at the “H” level) , so that the gate terminal G of the PMOS transistor 30 is at the “H” level and at the “OFF” state.

The gate terminals G of the NMOS transistor 41 and the NMOS transistor 47 are grounded and at the “L” level, so that they are in the “OFF” state.

The input and output terminal 52 of the system unit 14 is at the “L” level, so that the gate terminal G of the NMOS transistor 46 is also at the “L” level and in the “OFF” state.

First, the following describes an operation to drive the electronic device 10C with the built-in battery 11.

In the initial state, when the user presses the power supply button 17, the switch 17SW having the normally open contact point linked with the power supply button 17 is caused to be in the “ON” state.

As a result, the capacitor 31 is discharged via the current limiting resistor 33. When the voltage of the capacitor 31 reaches the voltage corresponding to the “L” level, the gate terminal G of the PMOS transistor 30 is caused to be at the “L” level and the PMOS transistor 30 is caused to be in the “ON” state.

In this case, the external direct current power supply is not connected to the direct current power supply terminal 12, so that the battery power supply control terminal 38 is at the “L” level. Accordingly, the PMOS transistor 42 is in the “ON” state, and the electric power of the built-in battery 11 is supplied to the system power supply terminal 51 of the system unit 14 via the PMOS transistor 42, the PMOS transistor 30, and the system power supply line SL. The system unit 14 can thus operate with the electric power supplied from the built-in battery 11 to control the entire electronic device 10C.

In this case, the electric power from the built-in battery 11 is supplied to the voltage dividing resistor 61 and the voltage dividing resistor 62, and the voltage (=“H” level) divided by the voltage dividing resistor 61 and the voltage dividing resistor 62 is applied to the gate terminal G of the NMOS transistor 41.

That is, the gate terminal G of the NMOS transistor 41 is caused to be at the “H” level and the NMOS transistor 41 is caused to be in the “ON” state.

Even when the user stops pressing the power supply button 17 after the NMOS transistor 41 becomes the “ON” state, the gate terminal G of the PMOS transistor 30 is maintained at the “L” level and the PMOS transistor 30 is continued to be at the “ON” state.

Accordingly, the electric power stored in the built-in battery 11 is continued to be supplied to the system power supply terminal 51 of the system unit 14 via the PMOS transistor 42 and the system power supply line SL, and the system unit 14 can operate with the built-in battery 11 to control the entire electronic device 10C.

The following describes an operation to stop the drive of the electronic device 10C by the built-in battery 11 and cause it to be in the factory-configured state.

In this case, the system unit 14 causes the input and output terminal 52 of the system unit 14 to be at the “H” level by performing screen setting or a special operation at an operation input module.

Accordingly, the gate terminal G of the NMOS transistor 46 is caused to be at the “H” level, so that the NMOS transistor 46 is caused to be in the “ON” state.

When the NMOS transistor 46 is at the “ON” state, the gate terminal G of the NMOS transistor 41 is grounded to be at the “L” level, so that the NMOS transistor 41 is caused to be in the “OFF” state.

As a result, the capacitor 31 is charged to be at the “H” level again and the gate terminal G of the PMOS transistor 30 is caused to be at the “H” level, so that the PMOS transistor 30 is caused to be in the “OFF” state.

Accordingly, the electronic device 10C is reset to the factory-configured state again, electrically separates and eliminates the dark current in the system unit 14, and can maintain residual capacity of the built-in battery 11 for a long time.

The following describes an operation to drive the electronic device 10C by connecting the external power supply.

In the initial state, when the external direct current power supply is connected to the direct current power supply terminal 12, the controller 24C causes the battery power supply control terminal 38 to be at the “H” level.

As a result, the gate terminal G of the PMOS transistor 42 is caused to be at the “H” level, so that the PMOS transistor 42 is caused to be in the “OFF” state.

Accordingly, the built-in battery 11 is electrically separated from the system power supply line SL.

The system power supply terminal 36 of the controller 24C is caused to be in a state in which the electric power supplied from the external direct current power supply can be supplied to the system power supply terminal 51 of the system unit 14 via the PMOS transistor 30 and the system power supply line SL.

In this state, the electric power from the external direct current power supply is also supplied to the voltage dividing resistor 48 and the voltage dividing resistor 49, and the gate terminal G of the NMOS transistor 47 is caused to be at the “H” level by the supplied electric power of which voltage is divided by the voltage dividing resistor 48 and the voltage dividing resistor 49.

Accordingly, the NMOS transistor 47 is caused to be in the “ON” state.

In a case in which the NMOS transistor 47 is in the “ON” state, when the user presses the power supply button 17, the switch 17SW having the normally open contact point linked with the power supply button 17 is caused to be in the “ON” state.

As a result, the capacitor 31 is discharged via the current limiting resistor 33. When the voltage of the capacitor 31 reaches the voltage corresponding to the “L” level, the gate terminal G of the PMOS transistor 30 is caused to be at the “L” level, the PMOS transistor 30 is caused to be in the “ON” state, and the system power supply terminal 36 of the controller 24C supplies the electric power supplied from the external direct current power supply to the system power supply terminal 51 of the system unit 14 via the PMOS transistor 30 and the system power supply line SL.

In this case, the NMOS transistor 41 is in the “ON” state, so that even when the user stops pressing the power supply button 17 thereafter, the gate terminal G of the PMOS transistor 30 is kept at the “L” level and the PMOS transistor 30 is continuously in the “ON” state.

Accordingly, the electric power supplied from the external direct current power supply is continuously supplied to the system unit 14, so that the system unit 14 controls the entire electronic device 10B and can continuously operate with the electric power supplied from the external direct current power supply.

The electric power from the external direct current power supply is supplied to the built-in battery 11 to be charged as necessary under the control of the charge and discharge control unit 13A.

As described above, according to the fourth embodiment, when the external direct current power supply is not connected, the system unit 14 is shut off from the built-in battery 11 until the user long-presses the power supply button 17. Accordingly, standby current is substantially zero, and it is possible to prolong the battery residual capacity maintainable period of the built-in battery 11.

When the external direct current power supply is connected, the system unit 14 operates with the electric power from the direct current power supply and can charge the built-in battery 11 as necessary.

### EFFECT OF EMBODIMENTS

As described above, according to the embodiments, at least the system unit 14 among the system unit 14 and the controller 24 is shut off from the built-in battery 11 until the user long-presses the power supply button 17. Accordingly, the standby current is substantially zero, and it is possible to prolong the battery residual capacity maintainable period of the built-in battery 11.

Specifically, because the system unit 14 and the controller 24 are shut off from the built-in battery 11, the standby current is substantially zero, and it is possible to further prolong the battery residual capacity maintainable period of the built-in battery 11.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A power supply circuit comprising:
a battery;
a first manually-operated switch comprising a normally open contact point;
a second switch having a closed state and an open state, wherein when in the closed-state, the second switch is configured to supply electric power of the battery to a target circuit, and when in the open state, the second switch is configured to shut off the electric power of the battery to the target circuit; and
a maintaining circuit configured to maintain the second switch in the closed state when the first switch is continuously closed for greater than or equal to a first time.

2. The power supply circuit of claim 1, wherein the maintaining circuit is configured to maintain the second switch closed based on a maintaining instruction signal supplied from the target circuit.

3. The power supply circuit of claim 1, wherein
the first switch comprises a mechanical contact point, and
the second switch comprises a semiconductor switch.

4. The power supply circuit of claim 1, wherein the second switch comprises a p-type metal-oxide-semiconductor (PMOS) transistor.

5. The power supply circuit of claim 3, wherein the maintaining circuit comprises a time constant circuit comprising a time constant corresponding to the first time, the time constant circuit configured to cause an electric potential of a gate terminal G of the PMOS transistor to be at an “L” level.

6. The power supply circuit of claim 5, wherein
the time constant circuit comprises an RC circuit comprising a resistor and a capacitor, and
the capacitor is connected to the gate terminal G of the PMOS transistor.

7. The power supply circuit of claim 1, wherein the maintaining circuit is configured to release the second switch from the closed state when a first release operation is performed.

8. The power supply circuit of claim 1, wherein the maintaining circuit is configured to operate by the electric power supplied from the battery.

9. The power supply circuit of claim 1, further comprising:
an external power supply terminal through which electric power can be supplied externally, wherein
the maintaining circuit is configured to close, when the first switch is closed while the electric power is supplied from the external power supply terminal, the second switch so that the closed state is maintained.

10. The power supply circuit of claim 9, wherein the maintaining circuit is configured to operate by the electric power supplied from the external power supply terminal.

11. An electronic device comprising:
the power supply circuit of claim 1; and
the target circuit.

12. The electronic device of claim 11, comprising a charge and discharge control unit configured to perform charge and discharge control of the battery, as the target circuit.

13. The electronic device of claim 11, comprising a system unit configured to control the electronic device, as the target circuit.
